(19) United States
(12) Patent Application Publication
(10) Pub. No.: US 2014/0282063 A1
(43) Pub. Date: Sep. 18, 2014

(54) SYSTEM FOR UPDATING ICON INTERFACE WITH ICONS OF DIFFERENT OPERATING SYSTEMS AND METHOD THEREOF

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/205,391

(22) Filed: Mar. 12, 2014

(30) Foreign Application Priority Data
Mar. 15, 2013 (CN) 2013100833400

(51) Int. Cl. G06F 3/0481

(52) U.S. Cl. CPC G06F 3/04817
USPC 715/746

(57) ABSTRACT

A method for updating a number of icons of different operating systems on one icon interface, includes, displaying the icon interface on a display unit of an electronic device. Controlling the host server to access an electronic market in response to an accessing request. Detecting whether an operation of a user is requesting to download and install an application from the accessed electronic market. If yes, determining whether one of the operating system servers connected to the host server has installed the requested application. If yes, accessing an operating system server running the operating system supporting the requested application and installing the requested application into the operating system server. And adding an icon corresponding to the requested application to the icon interface.

### CROSS REFERENCE TO RELATED APPLICATIONS

This application is related to the following co-pending, commonly assigned patent applications, the disclosures of which are incorporated herein by reference in their entirety:

1. “SYSTEM FOR APPLYING APPLICATIONS OF DIFFERENT OPERATING SYSTEMS IN ONE ELECTRONIC DEVICE AND METHOD THEREOF” by Steve Lap Wai Hui, whose Attorney Docket No is US51414.

2. “ELECTRONIC DEVICE WITH A FUNCTION OF APPLYING APPLICATIONS OF DIFFERENT OPERATING SYSTEMS AND METHOD THEREOF” by Steve Lap Wai Hui, whose Attorney Docket No is US51415.

3. “ELECTRONIC DEVICE WITH A FUNCTION OF APPLYING APPLICATIONS OF DIFFERENT OPERATING SYSTEMS AND METHOD THEREOF” by Steve Lap Wai Hui, whose Attorney Docket No is US51416.

4. “ELECTRONIC DEVICE WITH A FUNCTION OF APPLYING APPLICATIONS OF DIFFERENT OPERATING SYSTEMS, SYSTEM AND METHOD THEREOF” by Steve Lap Wai Hui, whose Attorney Docket No is US51417.

### BACKGROUND

1. Technical Field

The present disclosure relates to systems, and particularly to a system for updating an icon interface with icons of different operating systems, and a method thereof

2. Description of Related Art

Electronic devices, such as mobile phones and tablet computers, are more and more popular. Usually, the electronic devices install a certain operating systems, such as, a WINDOWS operating system, a LINUX operating system, or an ANDROID operating system. However, in general when the electronic device is running one operating system, only the applications of the entered operating system are displayed and can be applied.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a system for updating an icon interface with a number of icons of different operating systems.

FIG. 2 is a schematic diagram of an embodiment of an electronic device and a host server implying the system, of FIG. 1.

FIG. 3 is a schematic diagram of an embodiment of an icon interface.

FIG. 4 is a schematic diagram of another embodiment of an icon interface.

FIG. 5 is a schematic diagram of another embodiment of an electronic device and a host server implying the system, of FIG. 1.

FIG. 6 is a flowchart diagram of an embodiment of a method for updating an icon interface with a number of icons of different operating systems.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

FIG. 1 shows an embodiment of a system 100 for updating an icon interface with a number of icons of different operating systems. The system 100 includes a number of modules, which are a collection of software instructions executed by a processor. The modules include an interface providing module 11, an accessing module 12, an operation detection module 13, and a downloading and installation module 15.

FIG. 2 shows that in a first embodiment, the system 100 is implemented in a host server 230. The host server 230 is connected to an electronic device 200 and a number of operating system servers 300 via corresponding networks. In the embodiment, each operating system server 300 installs/runs one or more operating systems. For example, as shown in FIG. 2, a LINUX operating system is installed and run in a first operating system server 300, a WINDOWS operating system is run in a second operating system server 300, an ANDROID system is run in a third operating system server 300, and a MAC operating system is run in a fourth operating system server 300.

In the embodiment, the host server 230 includes a processing unit 231, the system are collection of software instructions and executed by the by the processing unit 231. The processing unit 231 can be a central processing unit, a digital processor, or a single chip, for example.

The electronic device 200 includes a display unit 201 and a communication unit 202. In the embodiment, the display unit 201 is a touch screen, in another embodiment, the display unit 201 can be a display screen and the display unit 201 combines a keyboard or a touchpad to constitute an input/output device. The electronic device 200 communicates with the host server 230 through the network via the communication unit 202. The network among the electronic device 200, the host server 230, and the number of operating system servers 300 can be an internet, an on-demand virtual lease line, a wireless network including WIFI and BLUETOOTH, a telecommunication network including a GPRS network, a CDMA network, or a broadcasting network. The network between the electronic device 200 and the host server 230 and the network between the host server 230 and the number of operating system server 300 can be the same or the different. The networks can be public network or private network. The communication unit 202 can be a communication chip complying with the corresponding network.

In the embodiment, the electronic device 100 can be a mobile phone, a tablet computer, a portable computer, or a desktop computer, for example. In another embodiment, the electronic device 100 can be a thin client, namely, a computer terminal device in a client-server system installed with a few applications. The operating system server 300 and the host server 230 can be virtual machines or physical machines.

FIG. 3 shows that the interface providing module 11 is used to provide an icon interface TS and display the icon interface TS on the display unit 201. FIG. 3 shows that the icon interface TS includes a number of icons TI, each of which corresponds to an application running in an operating system. For example, the icons TI include a browser icon TI1 applied in the LINUX operating system, namely the browser icon TI1 of the LINUX operating system, a media player 1 icon TI2 applied in the ANDROID system. As shown in FIG. 3, the icons TI corresponding to different operating systems are arranged in the icon interface TS randomly.

FIG. 4 shows that in another embodiment, each operating system is assigned with a corresponding area on the display unit 201 for locating the icons TI. For example, the icons TI belonging to the same operating system are located on the same row. Therefore, a user can operate and manage the icons TI of the same operating system conveniently.

In the embodiment, the interface providing module 11 provides the icon interface TS including the stored icons TI in response to an operation of connecting to the host server 230 by a user. In the embodiment, the operation of connecting to the host server 230 is an operation of connecting the electronic device 200 to the host server 230 via remote access.

The accessing module 12 is used to control the host server to access an electronic market, such as an ANDROID market, an Apple market, in response to an accessing request produced by a user.

The operation detection module 13 is used to detect whether an operation of a user is to request to download and install an application from the accessed electronic market.

The downloading and installation module 14 determines whether one of the operating system servers 300 has installed the requested application when the operation of the user is to request to download and install the application.

When the downloading and installation module 14 determines none of the operating system servers 300 installs the requested application, the downloading and installation module 14 accesses one operating system server 300 running the operating system supporting the requested application and installs the requested application into the accessed operating system server 300. In addition, adds an icon TI corresponding to the requested application to the icon interface TS. In the embodiment, the one operating system server 300 running the operating system supporting the requested application is one of the operating system servers 300 connected to the host server 230.

When the downloading and installation module 14 determines one operating system server 300 installs the requested application, the downloading and installation module 14 just adds the icon TI corresponding to the requested application to the icon interface TS.

In the embodiment, the downloading and installation module 14 also stores relationship information corresponding to each icon into the host server 230 after installing the application corresponding to the icon into the corresponding operating system server 300. The relationship information includes identification information of an application and identification information of a corresponding operating system. Therefore, when an icon TI of the icon interface TS is being selected, the host server 230 determines the operating system supporting to the application corresponding to the selected icon, and determines the operating system server 300 running the operating system, and then requests the determined operating system server 300 to execute the application.

In the embodiment, the host server 230 also stores network address, such as an internet protocol (IP) address of each operating system server 300. The host server 230 accesses to the searched operating system server 300 according to the network address of the determined operating system server 300.

In the embodiment, at least one operating system is installed and running in the host server 230. After the downloading and installation module 14 determines the host server 230 is running the operating system supporting the requested application, the downloading and installation module 14 then installs the application into the host server 230 directly.

FIG. 5 shows that in a second embodiment, the electronic device 200 includes the display unit 201, the communication unit 202, a processing unit 203, and a storage unit 204.

In the second embodiment, the interface providing module 11 is executed by the processing unit 203 of the electronic device 200, and the accessing module 12, the operation detection module 13, and the downloading and installation module 14 are executed by the host server 230. In the second embodiment, the downloading and installation module 14 stores the relationship information and each corresponding icons into the storage unit 204. The processing unit 203 can be a central processing unit, a digital processor, or a single chip, for example. The storage unit 204 can be a hard disk, a flash memory, or a compact disk, for example.

In the second embodiment, the interface providing module 11 provides the icon interface TS including the stored icons and displays the icon interface TS on the display unit 201 after the electronic device 200 is started up and enters a certain operating system, such as the ANDROID operating system.

FIG. 6 shows a flowchart of a method for updating an icon interface with a number of icons of different operating systems. At first, interface providing module 11 is used to provide an icon interface TS and display the icon interface TS on the display unit 201 (S601).

The accessing module 12 controls the host server to access an electronic market, such as an ANDROID market, an Apple market, in response to an accessing request produced by a user (S603).

The operation detection module 13 detects whether an operation of a user is to request to download and install an application from the accessed electronic market (S605). If yes, the process jumps to step S 607, else, the process is returned to the step S605.

The downloading and installation module 14 determines whether one of the operating system servers 300 connected to the host server 230 has installed the requested application when the operation of the user is to request to download and install the application (S607). If not, the process jumps to step S609, and if yes, the process jumps to step S611.

The downloading and installation module 14 accesses an operating system server 300 running the operating system supporting the requested application and installs the requested application into an operating system server 300 (S609).

The downloading and installation module 14 adds an icon TI corresponding to the requested application to the icon interface TS (S611).

Therefore, based on the system 100 and the method, the present disclosure enables one icon interface TS to display a number of icons TI of different operating systems.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for updating a plurality of icons of different operating systems on one icon interface, the system applied in at least one of a host server and an electronic device connected to each other, the system comprising:
a plurality of modules which are collection of instructions executed by one or more processors of the host server and/or the electronic device, the modules comprising:
an interface providing module configured to provide an icon interface and display the icon interface on a display unit of the electronic device;
an accessing module configured to control the host server to access an electronic market in response to an accessing request produced by a user;
an operation detection module configured to detect whether an operation of a user is to request to download and install an application from the accessed electronic market; and
a downloading and installation module configured to determine whether one of the operating system servers connected to the host server has installed the requested application when the operation of the user is to request to download and install the application; and to access one operating system server running the operating system supporting the requested application and install the requested application into the operating system server when determining none of the operating system servers installs the requested application, and then add an icon corresponding to the requested application to the icon interface.

2. The system according to claim 1, wherein the downloading and installation module is further configured to add the icon corresponding to the requested application to the icon interface directly when determining there is one operating system server has installed the requested application.

3. The system according to claim 1, wherein the downloading and installation module is further configured to store relationship information corresponding to each icon after installing the application corresponding to the icon into the corresponding operating system server; the relationship information comprises identification information of an application and identification information of a corresponding operating system.

4. The system according to claim 3, wherein the downloading and installation module stores relationship information into the host server.

5. The system according to claim 3, wherein the downloading and installation module stores relationship information into the electronic device.

6. The system according to claim 1, wherein the downloading and installation module accesses the operating system server running the operating system supporting the requested application according to a network address of the operating system server.

7. A method for updating a plurality of icons of different operating systems on one icon interface, the method applied in a host server and an electronic device connected to each other, the method comprising:
providing the icon interface and displaying the icon interface on a display unit of an electronic device;
controlling the host server to access an electronic market in response to an accessing request produced by a user;
detecting whether an operation of a user is to request to download and install an application from the accessed electronic market;
determining whether one of the operating system servers connected to the host server has installed the requested application when the operation of the user is to request to download and install the application;
accessing an operating system server running the operating system supporting the requested application and installing the requested application into the operating system server, when determining none of the operating system servers has installed the requested application; and
adding an icon corresponding to the requested application to the icon interface.

8. The method according to claim 7, further comprising:
adding the icon corresponding to the requested application to the icon interface directly when determining one of the operating system servers has installed the requested application.

9. The method according to claim 7, wherein the step of accessing an operating system server running the operating system supporting the requested application comprises:
accessing an operating system server running the operating system supporting the requested application via a network address of the operating system server.
